(19) United States
(12) Patent Application Publication
(10) Pub. No.: US 2016/0368450 A1
(43) Pub. Date: Dec. 22, 2016

(54) MOTOR VEHICLE WITH SAFETY BELT RESTRAINT SYSTEM

(71) Applicant: GM GLOBAL TECHNOLOGY OPERATIONS LLC, Detroit, MI (US)

(72) Inventor: Christian KUHLEY, Ruesselsheim (DE)

(73) Assignee: GM GLOBAL TECHNOLOGY OPERATIONS LLC, Detroit, MI (US)

(21) Appl. No.: 15/184,313

(22) Filed: Jun. 16, 2016

(30) Foreign Application Priority Data
Jun. 16, 2015 (DE) 202015004293.7

(51) Int. Cl. B60R 22/34; B60R 22/26

(52) U.S. Cl. CPC B60R 22/34; B60R 22/26; B60R 2022/266; B60R 2022/3402

(57) ABSTRACT

A safety belt restraint system is disclosed for a rear seat of a motor vehicle. The safety belt restraint system includes a safety belt and a belt retractor fastened to a mounting device. The mounting device includes a plurality of fasteners and a connecting part with which the belt retractor can be fastened to the mounting device. The connecting part can be fastened to at least one fastening element and to the belt retractor. The belt retractor is indirectly fastened by the mounting device to a support structure of the back part. The mounting device is an intermediate modular part, and no connecting part is fastened to the fastening element, so that various belt retractors, in particular with various connecting parts, can be fastened to the intermediate modular part.

### CROSS-REFERENCE TO RELATED APPLICATION

This application claims priority to German Patent Application No. 202015004293.7, filed Jun. 16, 2015, which is incorporated herein by reference in its entirety.

### TECHNICAL FIELD

The present disclosure pertains to a safety belt restraint system and a motor vehicle.

### BACKGROUND

Safety belt restraint systems are used in motor vehicles to reduce the risk of injury to the passenger(s) in the event of an accident. The safety belts are intended to restrain passengers of a motor vehicle in the vehicle seat given high decelerations encountered during a frontal impact due to a collision with other motor vehicles or objects. This makes it possible to avoid injuries to passengers caused by passengers being ejected from the motor vehicle or passengers hitting parts of the vehicle during such collisions. The seats exhibit a seat part and back part. Situated within an interior of the vehicle are front seats and rear seats. Three rear seats are generally combined into a rear seat bench.

As part of the safety belt restraint system, a belt retractor for the safety belt is fastened to the rear seat bench for the middle rear seat from the rear on the back part. Significant structural changes are necessary for fastening various belt retractors, disadvantageously resulting in higher costs, and requiring time-consuming adjustments to the manufacturing process.

DE 10 2012 010 338 A1 discloses a safety belt arrangement for a motor vehicle. The latter encompasses a safety belt, which is allocated to a backrest of a vehicle seat, and a belt retractor for a shoulder belt section of the safety belt mounted on the body side. The belt retractor is located below an upper end and behind the backrest, as well as a deflector mounted on the body side for the safety belt situated between the backrest and belt retractor, above the belt retractor. The belt retractor is bolted to a mounting bracket.

### SUMMARY

Therefore, the present disclosure provides a safety belt restraint system and a motor vehicle with a safety belt restraint system in which various belt retractors can be economically fastened to a back part of a seat with little technical outlay. In particular, a safety belt restraint system for a seat, for example a rear seat of a motor vehicle, encompasses a safety belt for the rear seat, a belt retractor, a mounting device to which the belt retractor can be fastened and/or is fastened, at least one connecting part to which the belt retractor can be fastened to the mounting device and/or is fastened to the mounting device, specifically by having at least one connecting part be fastenable and/or fastened to the at least one fastening element and to the belt retractor. The belt retractor can be indirectly fastened and/or is indirectly fastened by the mounting device to a support structure of the back part, and the mounting device is an intermediate modular part and no connecting part is fastened to at least one fastening element, so that various belt retractors, in particular with various connecting parts, can be fastened and/or are fastened to the intermediate modular part. As a consequence, the intermediate modular part acts as an adapter for fastening various belt retractors to an identical intermediate modular part and preferably identical support structure. The identical intermediate modular part can also be fastened or is fastened to various support structures. Therefore, various belt retractors can be easily and inexpensively fastened with a low modification outlay. The mounting device as the intermediate modular part can be fastened or is fastened to a back part of a front seat and/or rear seat.

The safety belt restraint system may encompass a deflection device for the safety belt. The belt retractor may also encompasses at least one counter-fastening element and the at least one connecting part can be fastened and/or is fastened to the at least one counter-fastening element. The counter-fastening element is formed on the belt retractor as an opening and/or a slit and/or an eyelet. The intermediate modular part is directly fastened to the support structure and/or lies directly on the support structure. The belt retractor is directly fastened to the intermediate modular part and/or lies directly on the intermediate modular part. Only the intermediate modular part is situated between the support structure and belt retractor in an area, in particular a partial area.

In a supplementary embodiment, the deflection device is fastened or can be fastened to the intermediate modular part, in particular by means of a substance-to-substance bond, preferably a welded joint. It is preferred that the fastening elements be designed on the intermediate modular part as an opening, a borehole, a slit and/or an eyelet, i.e., as a special form of the intermediate modular part.

In a supplementary embodiment, the connecting element is designed as a fastener such as a screw and/or rivet and/or bolt.

In another embodiment, the intermediate modular part is at least partially plate-shaped and/or the intermediate modular part is at least partially, in particular completely, made out of metal, in particular steel or aluminum.

In a supplementary variant, the connecting part, in particular all connecting parts, can be fastened and/or are fastened to the at least one fastening element of the intermediate modular part with a positive and/or non-positive connection.

In an additional embodiment, the intermediate modular part encompasses at least one additional fastening element configured as an opening and/or a slit and/or an eyelet. In a supplementary embodiment, the intermediate modular part is fastened and/or can be fastened to the support structure with at least one additional connecting part, preferably several additional connecting parts, by fastening and/or being able to fasten the an additional connecting part to the additional fastening element of the intermediate modular part and to the support structure.

A motor vehicle according to the present disclosure, encompassing a body, a drive motor, in particular an internal combustion engine or an electric motor, at least one front seat as a seat with a seat part and a back part, at least one rear seat as a seat with a seat part and back part, a safety belt restraint system for the seat, in particular rear seat, and a belt retractor of the safety belt restraint system fastened to the back part of the rear seat. The safety belt restraint system is designed as a safety belt restraint system described herein.

A method according to the present disclosure for manufacturing various motor vehicles, in particular various motor vehicles described herein. A safety belt restraint system is provided with a safety belt, a belt retractor and a mounting device, fastening various belt retractors to a support structure of a back part of a seat, in particular a rear seat or front seat of the motor vehicle, so that various motor vehicles are manufactured. Identical mounting devices are provided, and the various belt retractors are fastened to the support structures by fastening the various belt retractors to identical mounting devices and fastening the identical mounting devices to the support structures, so that the various belt retractors are indirectly fastened to the support structures with the identical mounting devices.

It is preferred that one belt retractor be fastened to each mounting device, and that one mounting device be fastened to each back part, in particular to one, preferably each, support structure of each back part. In a supplementary embodiment, the mounting devices are provided as intermediate modular parts, and the intermediate modular parts encompass several fastening elements, and at least one connecting part, preferably several connecting parts, is/are fastened to at least one fastening element, preferably several fastening elements.

In an additional embodiment, no connecting part is fastened to at least one fastening element, preferably several fastening elements, so that the at least one fastening element is provided without the connecting part fastened thereto so as to fasten differently designed connecting parts of differently designed belt retractors.

In another embodiment, a respective one belt retractor is first fastened to each intermediate modular part, after which a respective one intermediate modular part with the respective one belt retractor fastened thereto is fastened to a respective back part, in particular to the support structure of the respective one back part, and/or the provided intermediate modular parts are at least partially plate-shaped, and/or the provided intermediate modular parts are at least partially, in particular completely, made out of metal, in particular steel and/or aluminum.

In a supplementary embodiment, the intermediate modular parts are provided in such a way that the at least one fastening element is designed as an opening and/or a slit and/or an eyelet. The connecting part is provided as a fastener such as screw and/or a rivet and/or a bolt. The intermediate modular parts are provided in such a way that the intermediate modular parts encompass at least one additional fastening element, preferably designed as an opening and/or a slit and/or an eyelet. A respective one intermediate modular part with at least one additional connecting part is fastened to at least one additional fastening element of the intermediate modular part and to the support structure. The additional connecting part is provided as a fastener such as a screw and/or a rivet and/or a bolt. A respective one deflection device for the safety belt is fastened to a respective one intermediate modular part, in particular before fastening the belt retractor to the intermediate modular part. The deflection devices are provided as rings, in particular U-shaped rings or D-rings, or components with a slit for passing through the safety belt and/or a respective one deflection device is fastened to one respective intermediate modular part by at least one substance-to-substance bond, in particular a welded joint.

### BRIEF DESCRIPTION OF THE DRAWINGS

The present disclosure will hereinafter be described in conjunction with the following drawing figures, wherein like numerals denote like elements.

FIG. 1 is a side view of a motor vehicle;

FIG. 2 is an exploded view of a safety belt restraint system for a rear seat of the motor vehicle;

FIG. 3 is a perspective view of the safety belt restraint system according to FIG. 2;

FIG. 4 is a perspective view of an intermediate modular part of the safety belt restraint system according to FIG. 2, and

FIG. 5 is a rear view of a back part of a rear seat of the motor vehicle with the safety belt restraint system fastened to the back part.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

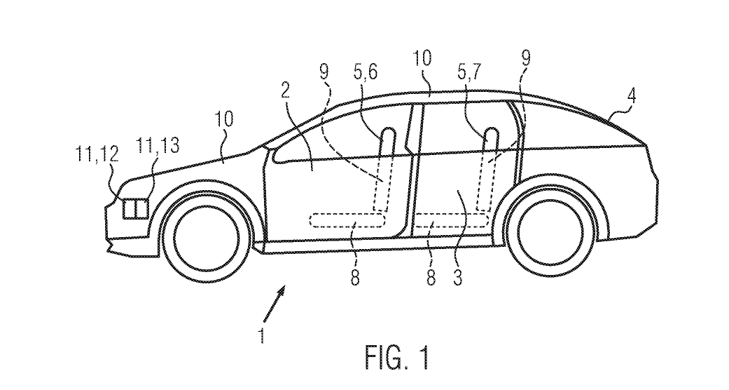

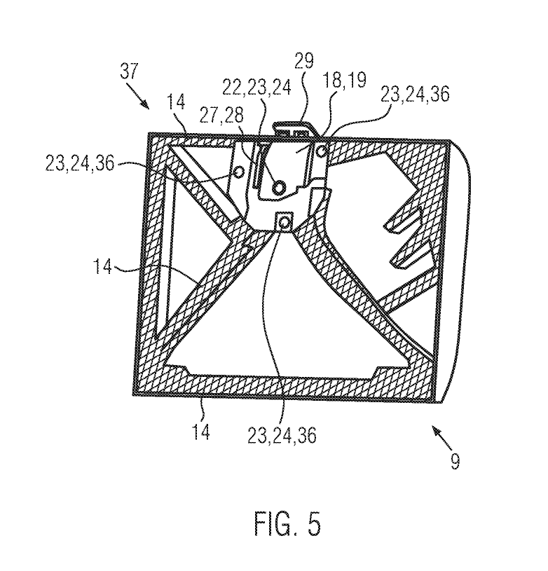

A motor vehicle 1 is depicted in FIG. 1 with a drive motor 11, for example an internal combustion engine 12 and/or electric motor 13, and exhibits a body 10. The body 10 encloses an interior with seats 5 including two front seats 6 and three rear seats 7. In particular, rear seats 7 located behind a front seat 6, for example in a second or third row behind the front seats 6. A front door 2 is used to get into and out of the front seats 6, and a rear door 3 is used to get into and out of the rear seats 7. A tailgate 4 is formed on the rear side of the motor vehicle 1. Each seat 5, whether a front seat 6 or rear seat 7, exhibits a respective seat part 8 and back part 9 with a seat cover, a cushion and a support structure 14. Three rear seats 7 may be combined into a seat bench, and the back part 9 of the three rear seats 7 may be divided into two parts, for example at a ratio of 1/3 to 2/3 such that one larger part serves as the back part 9 for two rear seats 7, and a smaller part serves as the back part 9 for a back seat 7. FIG. 5 presents a rear view of the larger part of the back part 9. The support structure 14 visible on FIG. 5 is made out of metal or plastic.

FIGS. 1 to 4 show an exemplary embodiment of a safety belt restraint system 37 for the middle rear seat 7. A first end of a safety belt 15 as a shoulder belt 16 is fixedly fastened to a fixing device 30 on the body 2. The other second end of the safety belt 15 is fastened to a belt retractor 17. The belt retractor 17 exhibits a roller and a torsion spring. An end area at the second end of the safety belt 15 is rolled onto the roller, so that the safety belt 15 can be adjusted to individuals of different sizes on the middle rear seat 7.

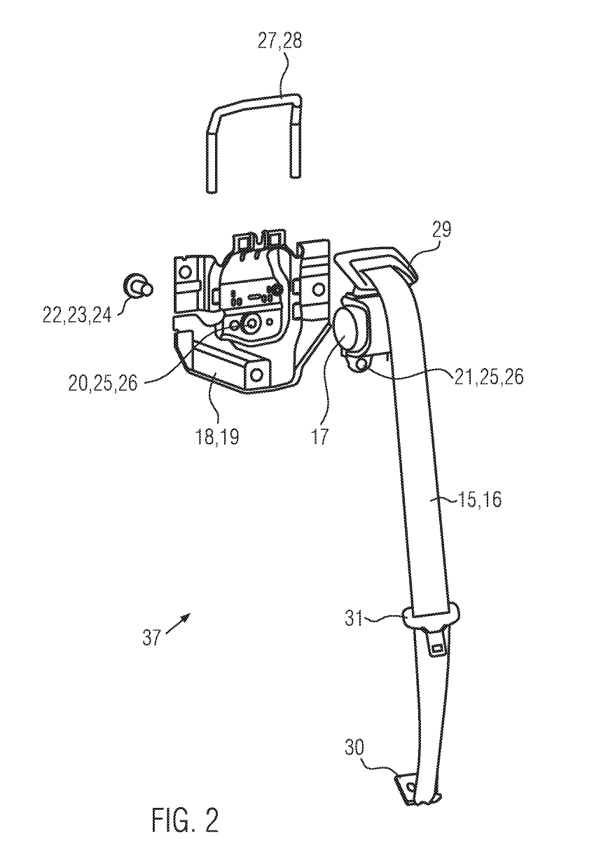

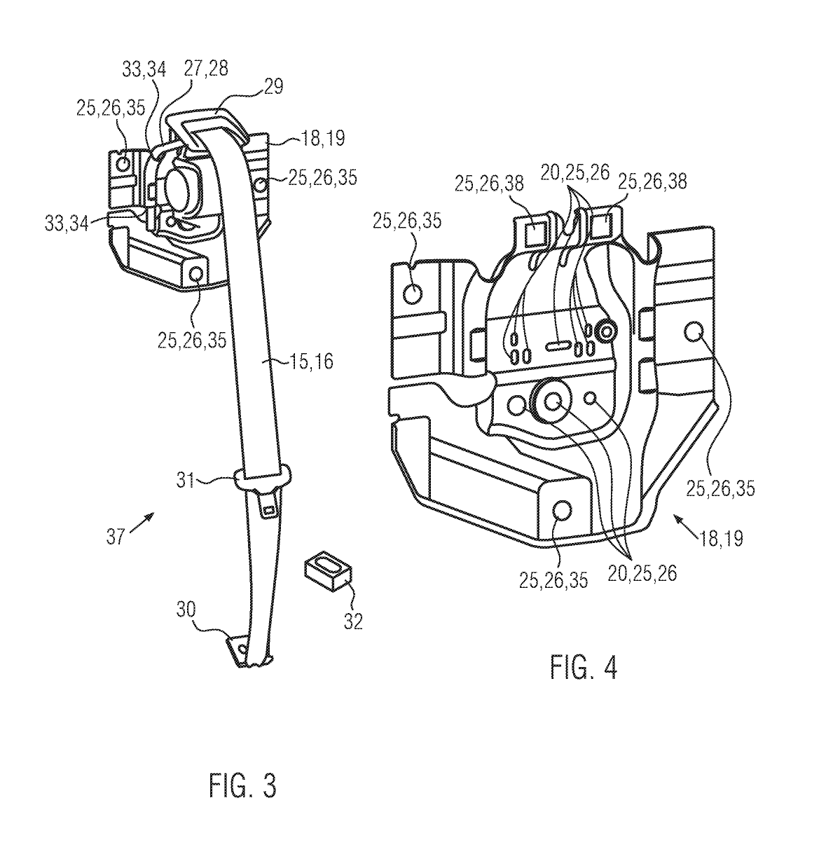

An additional deflection device 31 (FIGS. 2 and 3) exhibits a slit, through which the safety belt 15 is guided, and a latch plate to be latched to a belt buckle 32. The belt retractor 17 is indirectly fastened to the support structure 14 by a mounting device 18 as the intermediate modular part 19 made out of steel (FIG. 5). The intermediate modular part 19 includes a steel plate, which is shaped, in particular bent, to exhibit a spatial structure and have flat sections. The belt retractor 17 is fastened to the intermediate modular part 19 by two connecting parts 22 (only one connecting part is depicted on the figures), and the intermediate modular part 19 is fastened to the support structure 14 by additional connecting parts 36.

The connecting parts 22 and additional connecting parts 36 are designed as screws 23 or bolts 24. A plurality of fastening elements 20 were formed or fabricated via stamping on the intermediate modular part 19 as openings 25, i.e., boreholes 26. Fastening elements 20 generally take the form of a suitable geometry or shape on the intermediate modular part for positively and/or non-positively connecting to the intermediate modular part 19, a connecting part 22 and/or indirectly the belt retractor 17 without a connecting part 22. As a consequence, the fastening elements 20 can also be designed as eyelets or hooks or slits. This also holds true analogously for the counter-fastening elements 21, for example openings 25 or boreholes 26 on the belt retractor 17. In addition, this also holds true analogously for additional fastening elements 35 on the intermediate modular part 19 and additional counter-fastening elements on the support structure 14.

The screws 23 or bolts 24 as the connecting parts 22 are fastened to the belt retractor 17 by counter-fastening elements 21. The additional fastening elements 35 are used for positively and/or non-positively joining the additional connecting parts 36 with the intermediate modular part 19. The additional fastening elements are used for positively and/or non-positively joining the additional connecting parts 36 with the support structure 14.

While manufacturing the motor vehicle 1, an intermediate modular part 19 is first provided, for example by shaping, in particular bending, a plate made out of metal, and the fastening elements 20 and additional fastening elements 35 are formed via stamping. A deflection device 27 defining a U-shaped ring as the partial ring or U-shaped rod made out of steel is then welded to the intermediate modular part 19 by means of a welded joint 34 as the substance-to-substance bond 33.

The belt retractor 17 is thereupon fastened to the intermediate modular part 19 by the connecting parts 22, and a cover 29 made out of plastic with a slit for passing through the safety belt 15 is also fastened to the intermediate modular part 19 and/or the belt retractor 17. To this end, the intermediate modular part 19 exhibits cover fastening elements 38 as openings 25 or boreholes 26, to which the cover 29 can be fastened via detents. The fixing device 30 and belt buckle 32 are fastened to the body 10. The intermediate modular part 19 is fastened to an upper end of the support structure 14 on the back side, so that the safety belt 15 is guided out of the cover 29 in the area of an upper end of the back part 9.

The intermediate modular part 19 exhibits a plurality of fastening elements 20, preferably about ten fastening elements 20, and a respective one connecting part 22 is fastened to only two fastening elements 20 in the exemplary embodiment described above. The other fastening elements 20 are used to fasten belt retractors 17 with a different structural configuration to the intermediate modular part 19 using other connecting parts 22. Other connecting parts 22 are regarded both as connecting parts 22 with a different structural design, for example with another diameter, as well as connecting parts 22 that are to be fastened to the intermediate modular part 19 in another position, but are structurally no different.

Viewed overall, significant advantages are associated with the safety belt restraint system 37 according to the present disclosure and the motor vehicle 1 according to the present disclosure. Given the high number of different attachment elements 20, varying belt retractors 17 can be modularly fastened to identical support structures 14 and identical intermediate modular parts 19. For example, when changing a supplier for the belt retractors 17, an automobile manufacturer can thus fasten the other belt retractors 17 without more extensive modification just by using other connecting parts 22 that fasten structurally different belt retractors 17 to the otherwise identical motor vehicle 1. This makes it possible to reduce costs and make manufacturing flexible.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-10. (canceled)

11. A safety belt restraint system for a seat of a motor vehicle comprising:
a safety belt configured for the seat;
a belt retractor;
a mounting device to which the belt retractor is fastened, the mounting device including a plurality of fastening elements;
at least one connecting part for fastening the belt retractor to the mounting device, wherein the at least one connecting part is fastened to the at least one fastening element and to the belt retractor;
wherein the belt retractor is configured to be indirectly fastened to a support structure of the back part by the mounting device, and the mounting device include an intermediate modular part such that no connecting part is directly fastened to at least one fastening element for enabling a second belt retractor with a second connecting part to replace the belt retractor and be fastened to the intermediate modular part.

12. The safety belt restraint system according to claim 11, further comprising a deflection device for the safety belt, wherein the belt retractor includes at least one counter-fastening element, and the at least one connecting part is fastened to the at least one counter-fastening element.

13. The safety belt restraint system according to claim 12, wherein the deflection device is fastened to the intermediate modular part with a substance-to-substance bond.

14. The safety belt restraint system according to claim 11, wherein the fastening elements comprise at least one of an opening or a borehole configured on the intermediate modular part.

15. The safety belt restraint system according to claim 11, wherein the at least one connecting element comprises at least one of a screw or a bolt.

16. The safety belt restraint system according to claim 11, wherein the intermediate modular part comprises plate-shaped structure.

17. The safety belt restraint system according to claim 11, wherein the at least one connecting part are fastened to the at least one fastening element of the intermediate modular part with a positive connection.

18. The safety belt restraint system according to claim 11, wherein the at least one connecting part are fastened to the at least one fastening element of the intermediate modular part with a non-positive connection.

19. The safety belt restraint system according to claim 11, wherein the intermediate modular part comprises at least one additional fastening element.

20. The safety belt restraint system according to claim 19, wherein the intermediate modular part is fastened to the support structure with at least one additional connecting part for fastening the at least one additional connecting part to the at least one additional fastening element of the intermediate modular part and to the support structure.

21. A motor vehicle comprising a body, a drive motor, at least one front seat having a first seat part and a first back part, at least one rear seat having a second seat part and a second back part, and a safety belt restraint system according to claim 11.
